(19) United States
(12) Patent Application Publication
(10) Pub. No.: US 2025/0342068 A1
(43) Pub. Date: Nov. 6, 2025

(54) METHOD AND SYSTEM FOR IDENTITY BROKERAGE FOR CLOUD ACCESS

(71) Applicant: JPMorgan Chase Bank, N.A., NEW YORK, NY (US)

(72) Inventors: Jared D. Mitten, Chillicothe, OH (US); Kabron A. Kline, Grove City, OH (US); Godfrey PAUL, Cliffsend (GB); Chinedu E. GENEKANWA, West New York, NJ (US); Michael C. JORGENSON, Columbus, OH (US); Ian Miller, London (GB)

(73) Assignee: JPMorgan Chase Bank, N.A., NEW YORK, NY (US)

(21) Appl. No.: 19/047,989

(22) Filed: Feb. 7, 2025

Related U.S. Application Data
(60) Provisional application No. 63/559,500, filed on Feb. 29, 2024.

(51) Int. Cl. G06F 9/50; H04L 9/40

(52) U.S. Cl. CPC G06F 9/5077; H04L 63/102

(57) ABSTRACT

There are provided methods and systems for cloud access control. For example, a method is provided as instructions on a non-transitory computer-readable medium. The instructions may be configured to cause a processor to perform certain operations. The operations can include receiving information about a connecting entity, and the connecting entity seeking to establish a connection to a cloud environment. The operations can further include determining, based on a policy, one or more attributes associated with the connecting entity. The operations may also include partitioning the cloud environment, according to one or more attributes.

### CROSS-REFERENCE TO RELATED APPLICATIONS

This application claims benefit to Provisional Patent Application No. 63/559,500, filed Feb. 29, 2024, the disclosure of which is incorporated herein in its entirety, by reference.

### TECHNICAL FIELD

The present disclosure relates to applications, methods, and systems for managing access to a cloud or a partition thereof.

### BACKGROUND

Large organizations face many challenges when trying to adopt cloud platforms. Among these challenges is the management of user identity (human or machine) permissions in cloud environments. Attribute-based access control (ABAC) aims to reduce this problem by providing organizations with the ability to create granular and flexible resource access policies. However, large organizations still face challenges with the assignment of attributes to users. Furthermore, it becomes difficult to ensure that those attributes are reduced to smallest amount of granular access needed for a user to perform a job function or task to ensure least privileged access is being used. In other words, it may be wasteful and/or it may constitute a security risk to assign more permissions or privileges than are needed for conducting a particular task.

Moreover, across one team (or across a cluster of machines), users may have different roles and tasks, and assigning attributes that are the same for every member is inefficient. Generally, for large organizations, especially those operating in heavily regulated industries, these challenges can lead to significant costs, and they can reduce the efficiency of cloud platform adoption. Accordingly, there is a need for a method and systems for managing attributes to users based on a defined policy when utilizing ABAC for cloud access control. Furthermore, users establishing a session in a cloud environment need the ability to specify a scope of access for a session so that they can perform activities with least-privilege attributes.

### SUMMARY

The embodiments featured herein help solve or mitigate the above noted issues as well as other issues known in the art. For example, the embodiments provide novel systems and methods for managing access to cloud environments at scale and for organizations with complex requirements. Access management may include enabling least privileged access to a cloud environment, and such a cloud environment may be a public cloud. Further, the embodiments provide a method to automate the assignment of attributes to users based on a defined policy when utilizing ABAC for cloud access. Furthermore, according to the embodiments, users establishing a session in a cloud environment may specify a scope of access for a session so that they can perform activities with least-privilege attributes. In view of these features and advantages, two non-limiting embodiments are described generally below.

In a first example embodiment, there is provided an exemplary method residing as instructions on a non-transitory computer-readable medium. The instructions may be configured to cause a processor to perform certain operations. The operations can include receiving information about a connecting entity, and the connecting entity seeking to establish a connection to a cloud environment. The operations can further include determining, based on a policy, one or more attributes associated with the connecting entity. The operations can also include partitioning the cloud environment, according to the one or more attributes.

In a second embodiment, there is provided a system including a processor and a memory including instructions, which when executed, cause the processor to perform certain operations. The operations can include receiving information about a connecting entity, the connecting entity seeking to establish a connection to a cloud environment. The operations can further include determining, based on a policy, one or more attributes associated with the connecting entity. The operations can also include partitioning the cloud environment, according to the one or more attributes.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates an example use case of in accordance with one or more embodiments of the present disclosure.

FIG. 2 illustrates an exemplary set of permissions or attributes for several users according to the embodiments.

FIG. 3 illustrates a first exemplary method of practicing various aspects of the present disclosure according to the embodiments.

FIG. 4 illustrates a second exemplary method of practicing the various aspects of the present disclosure.

FIG. 5 illustrates a third exemplary method of practicing the various aspects of the present disclosure.

FIG. 6 illustrates an exemplary entitlement attribute group according to the embodiments.

FIG. 7 illustrates an exemplary table depicting relationships between membership policies, attribute policies, and the assignment of attributes to a user, according to the embodiments.

FIG. 8 is a block diagram illustration of an exemplary computer system upon which the described embodiments may be implemented.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

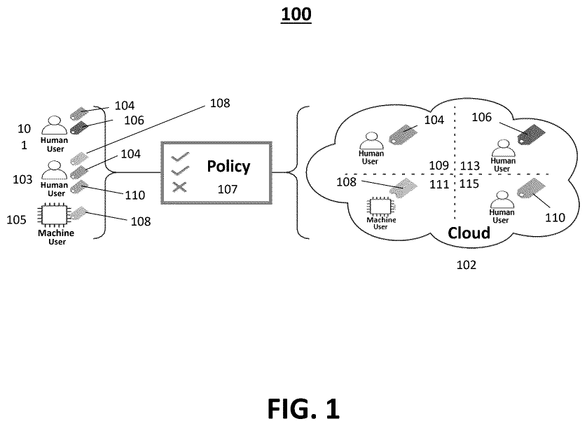

FIG. 1 illustrates a use case 100 according to the one or more exemplary embodiments. For example, an organization may have a plurality of users (e.g., 101, 103, and 105) requiring access to a cloud 102. The cloud 102 may be a public cloud. The plurality of users may include human users and machine users. Without limitation, the latter category may include virtual machines, physical machines, and applications automatically requesting access to the cloud 102 with or without human user intervention.

In the exemplary embodiment of FIG. 1, the organization may assign, based on a pre-assigned or pre-established policy 107, a set of permissions, attributes, and privileges to each user in the plurality of users. The policy 107 may be a data structure that includes a set of permissions and/or attributes that codify rights and privileges associated with each user in the plurality of users. For instance, the user 101 may have permission 104 and permission 106. The user 103 may have permission 104, permission 108, and permission 110. The user 105 may have permission 108.

In the exemplary embodiment, based on the one or more attributes (e.g., the aforementioned permissions) of each user, an exemplary system according to the teachings presented herein may partition the cloud 102 into access sections 109, 111, and 113, and 115, each section being restricted to one or more users having the correct permission for that section.

For instance, a user having a permission 104 may be granted access to section 109. A user having permission 106 may be granted access to section 113. A user having permission 110 may be granted permission to access section 115. A user having permission 108 may be granted 111. In each case, the user having been granted access to a particular access section is at least privileged to the set of permissions or attributes for accessing that section.

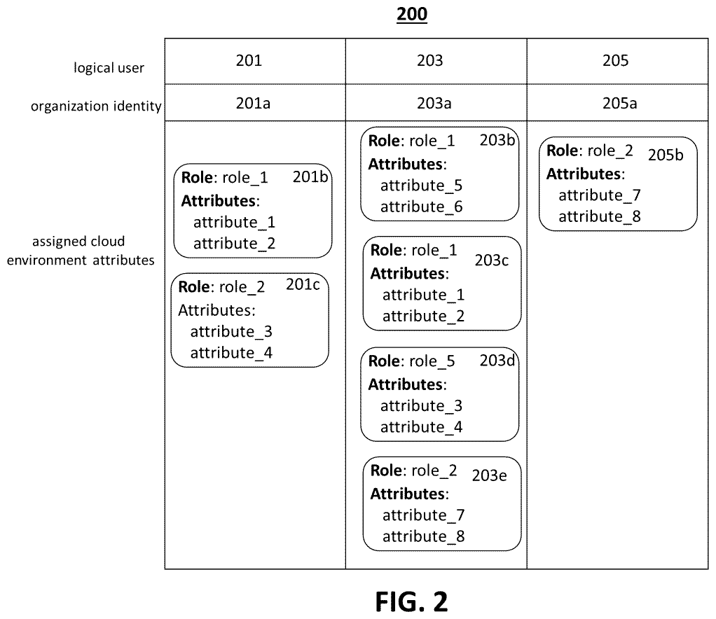

FIG. 2 illustrates a set of permissions 200 implemented for a set users using a public cloud environment. By way of example only, and not limitation, one example of such a public cloud environment obtained from a public cloud vendor. Other public cloud environments are known to those of skill in the art and would be within the spirit and scope of the embodiments. Each logical user (201, 203, and 205) are assigned an identifier (201a, 203a, and 205a, respectively). As stated in the use case 100, the policy 107 may include attributes for each of the users. For example, and not by limitation, the user 201 may be assigned cloud attributes 201b and 201c, based on the role associated with the user 201. The user 203 may be associated with attributes 203b, 203c, 203d, and 203e. The user 205 may be associated with attributes 205b.

The embodiments confer several advantages. For example, with the embodiments is that organizations can utilize ABAC to partition a cloud environment across multiple tenants using resource access controls based on organizational attributes assigned to the user's identity. This allows organizations to reduce the number of cloud environments required and can provide significant cost reductions.

Typically, one key issue resulting from utilizing ABAC for this approach to partition groups of resources in a cloud environment is that users can be assigned attributes (or sets of attributes) for multiple groups of resources. There is a burden on the organization to maintain multiple cloud identity roles for users in a single cloud environment. In contrast, with the embodiments, this burden can be reduced by partitioning the cloud environment based on attributes assigned to users while maintaining a single cloud security principal role identity for all users.

Furthermore, typically, resource access policies can limit the scope of access while still allowing all users to utilize the same cloud security principal role identity. Users may have access to multiple partitions of the cloud environment for different business purposes (e.g., team maintains multiple applications), the user must be able to select a particular subset of assigned user attributes when establishing a login session in the cloud platform. However, with the embodiments, an exemplary system may be configured to scope access and provide functionalities that include, but are not limited to: (1) conferring the ability to an organization to assign multiple sets of attributes associated with the same cloud platform security principal and (2) conferring the ability to a user to select a particular subset of assigned user attributes to scope the users access to only what is needed for accessing an environment.

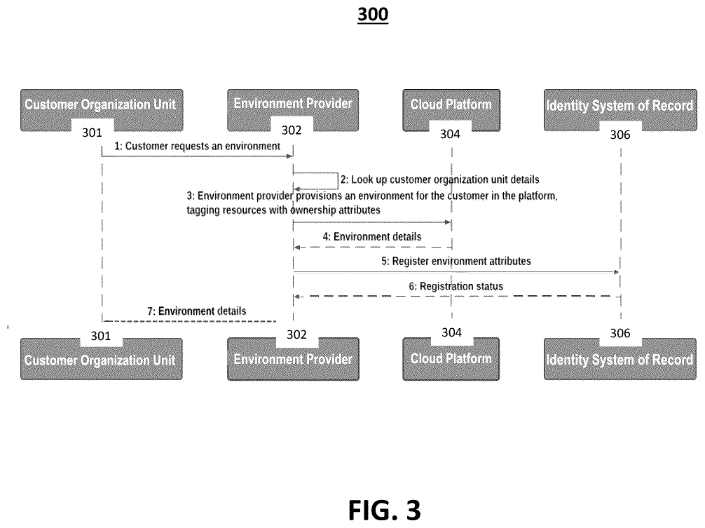

FIG. 3 shows an exemplary method 300 according to another exemplary embodiment. The method 300 may be used to register cloud environments in an organizational system of record. Specifically, when a platform service team provisions a cloud environment for a customer within an organization, the organization's system must have a way for the attributes of the environment to be registered. This is also true when security principals within the environment are created. Organizational units that create environments for other customers in the organization are referred to as Environment Providers. The provisioning concepts described below, within the context of the method 300, constitute additional features and benefits of the embodiments as they enable the capabilities for large organizations to more easily manage the attributes of the system.

When a cloud environment provider provisions an environment for a customer, the attributes associated with that environment must be created and registered in an organization system of record. The method 300 is an example sequence that captures this process. The method 300 may feature a system disposed at, or controlled by, an environment provider 302. The system may receive (at block 1) data from a customer organization unit 301, the data may be a message, a data structure, or the like, which indicates to the environment provider 302 that the customer organization unit 301 wishes to request an environment in a cloud platform 304. At block 2, the system of the environment provider 302 may be configured to loop cup customer organization unit details in a database accessible to the system.

At block 3, the system of the environment provider 302 may provision an environment for the customer in the cloud platform 304, tagging resources with ownership attributes. At block 4, the system of environment provider 302 may extract environment details from the cloud platform 304 and subsequently, at block 5, register the environment attributes in an identity system of record 306. At block 6, the identity system of record 306 may communicate a registration status to the system of the environment provider 302, and at block 7, the environment provider 302 system may communicate the environment details to the customer organization unit 301.

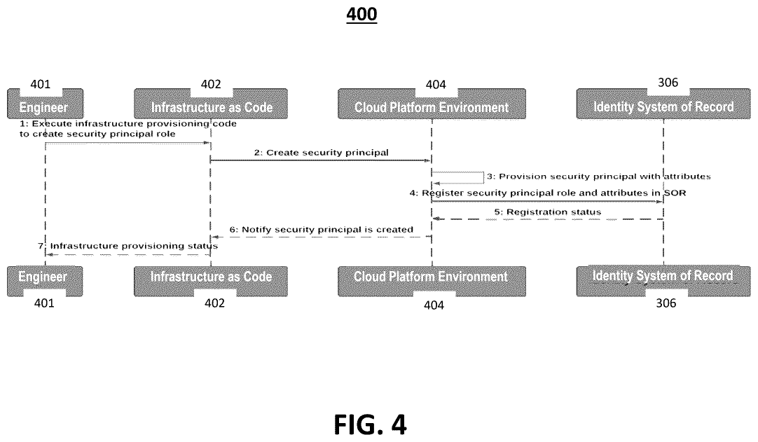

FIG. 4 shows a method 400 according to another exemplary embodiment. The method 400 is configured to security roles after a customer has been given a cloud platform environment 404. After being granted an environment, the system of the environment provider 302 (FIG. 3) desirably provisions security principal roles for accessing the environment. In this embodiment, this may be achieved using infrastructure as code tools (e.g., Terraform). The role identities in the platform may be tagged with attributes and registered in the organization's identity system of record 306 so that access can be granted to assume the role.

The method 400 illustrates this scenario. At block 1, an engineer, or generally a machine communicatively coupled to the environment provider 302 system may be configured to execute infrastructure provisioning code to create a security principal role. This may be done using an infrastructure as code module 402. At block 2, the method 400 includes creating the security principal for the cloud platform environment 404 and further, it may include provisioning a security principal with the attributes of the cloud platform environment 404 at block 3. The system may then update the registration status at block 5 in the identity system of record 306. Upon the security being created, at block 6, a notification may be sent to the engineer 401 or the customer organization unit 301. Similarly, infrastructure provisioning status may be sent to both at block 7.

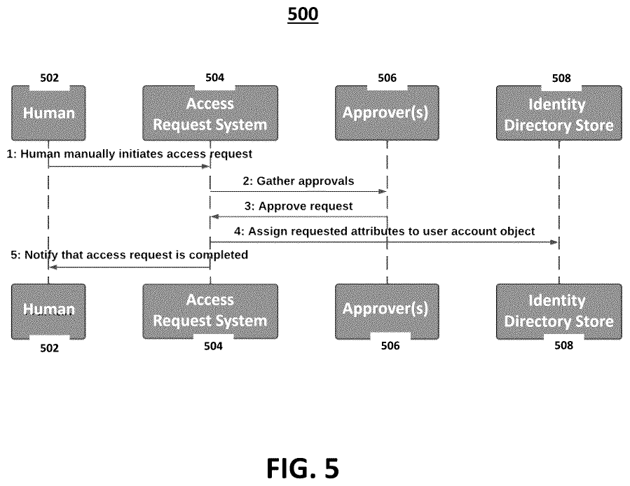

FIG. 5 illustrates an exemplary method 500 wherein the system of the environment provider 302 may be used to achieve manual access management. In a traditional access management approach, a user in an organization would raise a request to assign a particular attribute to a user that grants access to a resource. This manual request process also requires a manual approval by one or more entities to result in the requested attribute assignment being granted. The method 500 is configured to enable this scenario.

In the method 500, at block 1, a human user 502 may manually initiate an access request to an access request system 504, which may be a subsystem of the environment provider's (302) system. At block 2, the access request system 504 may be configured to gather approval from one or more approvers 506, which may, at block 3, approve the request. At block 4, the access request system 504 may then assign requested attributes to a user account object in an identity director store which may be part of the identity system of record 306. At block 5, the access request system 504 may provide a notification that the access request is completed and granted to the human user 502.

In this exemplary manual approach of requesting access and approving access, access may be easily provisioned. However, such a manual approach is not scalable as an approver could become a bottleneck for the process. Furthermore, complications may arise as teams grow or shrink and this may result in new requests that need to be raised, creating friction points for workers.

As such, another embodiment disclosed herein provides an automated access management feature. Such an automated system provides the flexibility for various organization units to define their own assignment policies based on technical requirements. The capability to automate the assignment of attributes to users based on policies is another advantageous functionality provided by this embodiment.

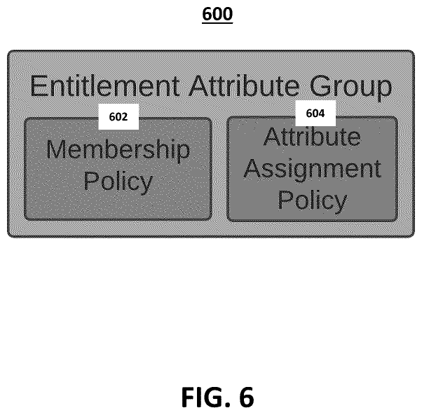

FIG. 6 illustrates an exemplary entitlement attribute group 600 that can be used for provisioning automated access. In this exemplary embodiment, an entitlement attribute group 600 represents a collection of attributes that may be assigned to a set of users who are members of the group. A fundamental distinction between an entitlement attribute group and a traditional group used for access management is that an entitlement attribute group represents a pair of defined policies (602 and 604) that are managed by an organization and are therefore subject to the organization's approval.

By way of example, a membership policy 602 consists of rules that are used to determine if a user is in scope for entitlement attribute assignment. These rules identify users via organizational attributes that originate from a system of record that contains attributes about a user's assigned managers, lines of business, cost centers, and projects amongst others. Users are dynamically added or removed as members from entitlement attribute groups based on changes to those organizational attributes.

The membership policy 602 determines the set of users in the organization who should be assigned attributes. Users who do not meet the membership policy criteria will not be added to the group. This also holds true for existing users. If a user previously had membership to a group, but an organizational change was made and the user no longer meets the membership criteria, then the user will be removed from the attribute group. Thus, they will lose all associated attributes (if they had any assigned). Membership in an attribute group does not automatically grant those users assignment of particular attributes. Instead, it puts the members in scope for evaluation of the attribute assignment policy 604.

The attribute assignment policy 604 determines if a particular attribute should be assigned to a user. Put in a different way, it specifies one or more entitlement attributes to assign and the set of users in the group who should be assigned that attribute. This means some users in the group may have varying attribute sets. Attribute assignment policies are not evaluated for users who do not meet the group membership policy criteria. Attributes assigned to a user by an attribute group are intended exclusively for controlling access to resources. These types of attributes are referred to as entitlements.

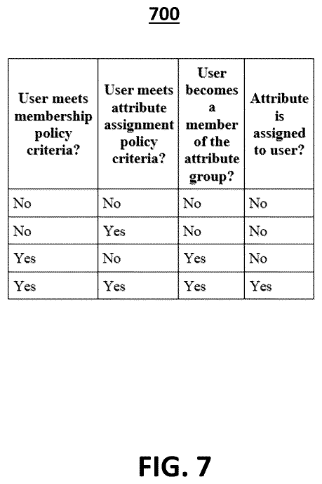

FIG. 7 illustrates one non-limiting example depicting a relationship between membership policies, attribute policies, and the assignment of attributes to a user. These relationships are outlined in table 700 of FIG. 7.

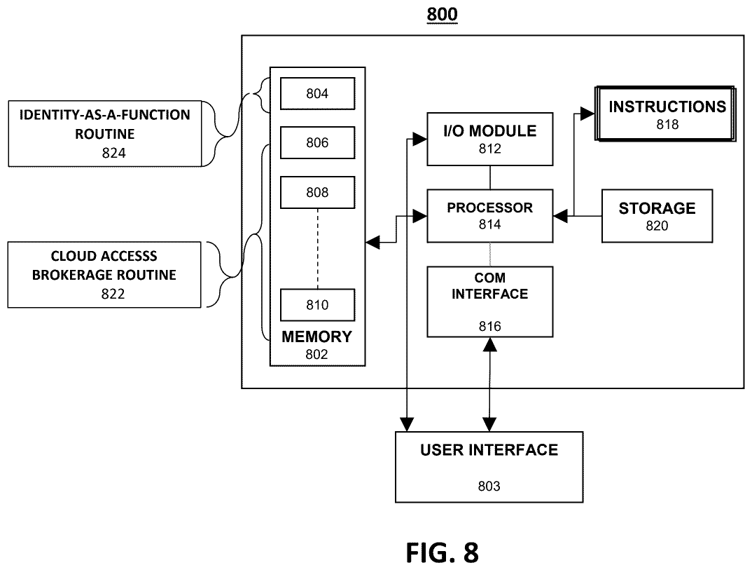

FIG. 8 describes an exemplary computer system 800 configurable to execute the various methods and processes described above. In the system 800, each of or all of the various methods described herein, such as the entitlement group, may be embodied in the system 800. For example, the various methods may be embodied as instructions residing in a non-transitory component such as a memory or a storage device associated with the system 800. That is, the structure of the system 800 is imparted to it by the methods described herein in the form of instructions.

The system 800 may be an application-specific hardware, software, and firmware implementation (or a combination thereof) of the system 100 as it is configured to execute the methods described herein. The system 800 may also represent a structural and application-specific implementation of a cloud access brokerage system like the system 100. The system 800 can include a processor 814 configured to execute one or more, or all of the blocks of the methods 200, 300, 400, and 500 depicted in FIGS. 2-5, respectively.

The processor 814 can have a specific structure imparted thereto by instructions stored in a memory 802 and/or by instructions 818 fetchable by the processor 814 from a storage medium 820. The storage medium 820 may be co-located with the system 800 as shown, or it can be remote and communicatively coupled to the system 800. Such communications may be encrypted.

The system 800 may be a stand-alone programmable system, or a programmable module included in a larger system. For example, the system 800 can be included as part of an environment provider infrastructure. Also, the system 800 may include one or more hardware and/or software components configured to fetch, decode, execute, store, analyze, distribute, evaluate, and/or categorize information.

The processor 814 may include one or more processing devices or cores (not shown). In some embodiments, the processor 814 may be a plurality of processors, each having either one or more cores. The processor 814 can execute instructions fetched from the memory 802, i.e., from one of memory modules 804, 806, 808, or 810. Alternatively, the instructions can be fetched from the storage medium 820, or from a remote device connected to the system 800 via a communication interface 816. An input/output (I/O) module 812 may be configured for additional communications to or from remote systems or to a user interface 803 from which the processor 814 may receive a set of requirements. Such additional communications may be facilitated by a communications interface 816.

Without loss of generality, the storage medium 820 and/or the memory 802 can include a volatile or non-volatile, magnetic, semiconductor, tape, optical, removable, non-removable, read-only, random-access, or any type of non-transitory computer-readable computer medium. The storage medium 820 and/or the memory 802 may include programs and/or other information usable by processor 814, such as for example, instructions that enable the processor 814 to execute the cloud environment access methods described herein. Furthermore, the storage medium 820 can be configured to log data processed, recorded, or collected during the operation of the system 800.

The data may be time-stamped, location-stamped, cataloged, indexed, encrypted, and/or organized in a variety of ways consistent with data storage practice. By way of example, the memory modules 804 to 810 can form instructions that embody a method for brokering access control to a cloud, as discussed in the context of the system 100 and the methods 200-500, the entitlement group 600, and the table shown in FIG. 7.

In other words, the memory modules 804 to 810 may form a cloud access brokerage routine 822 that can cause the processor 814 to perform certain operations upon execution. For example, the operations can include receiving information about a connecting entity, the connecting entity seeking to establish a connection to a cloud environment. The operations can further include determining, based on a policy, one or more attributes associated with the connecting entity. The operations may also include partitioning the cloud environment, according to the one or more attributes.

In addition to the cloud access brokerage routine 822, the memory module 802 may include instructions that cause the processor 814 to execute an identity-as-a-function method or access-as-a-function method, or generally, as depicted in FIG. 8. In the routine 824, one or more users (human or machine or a set including both) may be granted authorization to access a protected resource; this is referred to in short as an “authorization grant.”

In many cases, authorization grants are provisioned via a member of an organization submitting an access request which must be approved by one or more other members of the organization. Often, this method for provisioning an authorization grant is described as being “manual”, as in “manual approval” or “manual request and approval”, because human effort is required for each authorization grant. When an authorization grant is approved it is fulfilled and the end result is that a user has permission to perform some action(s) on some resource(s).

There is a significant amount of toil involved with manually provisioned authorization grants. Approval decisions made by humans cannot be automated with software because the approval rules are not codified into rules (policies) that a machine or software can interpret or understand. Manually provisioned authorization grants must be periodically recertified to ensure an ongoing need for access which requires reoccurring human effort. Human approvers are often unsure about what it is they are approving, and they are typically reluctant to deny or revoke an existing authorization grant on the basis that it might cause an operational impact on the organization, this ultimately results in users having access not based on organizational need (aka “overprovisioned” or “over-permissioned”).

When a user attempts to access a protected resource the resource server must authorize the requested access by validating the user has the necessary authorization grant. A resource server determines if a user has the necessary authorization grant via two authorization subroutines, which may be a decision subroutine and an enforcement subroutine.

In the decision subroutine, an authorization policy is evaluated to determine if a user is authorized to perform a requested action on a target resource. There are two possible authorization decisions: permit or deny. An authorization decision may also contain a (optional) set of obligations which are things that the enforcer of an authorization decision must do. Obligations are a way to communicate data stored in an authorization policy for use during enforcement. In the enforcement subroutine an authorization decision, permit or deny, is interpreted along with any corresponding obligations in the resource server's enforcement point. In the event of a deny decision, the resource server does not allow the requested action to take place on the target resource. In the event of a permit decision, the resource server allows the requested action to take place on the target resource. In either event, if the decision has any corresponding obligations they must be understood and appropriately actioned by the resource server enforcement point.

Access as a function is a type of distributed function that executes across a distributed system and involves the evaluation of a set of authorization policies and a set of attributes about a subject (user identity), resource, and action. Subject attributes necessarily include attributes assigned via an entitlement attribute group. The set of authorization policies includes an entitlement attribute group membership policy, an entitlement attribute group attribute assignment policy, an authorization server resource specific token issuance policy, and a resource server authorization policy. Existing resource server applications that currently rely on manually requested and/or manually approved user attributes for authorization do not necessarily need to make any changes to benefit from access as a function. If for example, an existing resource server application relies on user group memberships that are manually requested and/or manually approved an attribute entitlement group can be used to automate user group assignment via approved membership policy without any change to the resource server application.

Having described several aspects and implementations of the novel methods and systems contemplated in this disclosure, the teachings presented herein are not described in the context of several general embodiments. For example, there is provided an exemplary method residing as instructions on a non-transitory computer-readable medium. The instructions may be configured to cause a processor to perform certain operations. The operations can include receiving information about a connecting entity, the connecting entity seeking to establish a connection to a cloud environment. The operations can further include determining, based on a policy, one or more attributes associated with the connecting entity. The operations can include partitioning the cloud environment, according to the one or more attributes.

The operations can further include granting access to the cloud environment following the partitioning, and the partitioning can include provisioning one or more groups of resources for the connecting entity. The operations can further include maintaining a cloud security principal role identity for the connecting entity, and the operations can further include providing a specified set of attributes to the connecting entity upon establishing a connection to the cloud environment. The method can further include assigning multiple sets of attributes to a cloud platform security principal, and the method can further include provisioning the connecting entity with only the resources needed for accessing the cloud environment based on the determined one or more attributes. The operations can further include granting access includes establishing a least privileged session for the connecting entity based on the determined one or more attributes, and the policy includes a permissions policy.

In yet another embodiment, there is provided a system including a processor and a memory including instructions, which when executed, cause the processor to perform certain operations. The operations can include receiving information about a connecting entity, the connecting entity seeking to establish a connection to a cloud environment. The operations can further include determining, based on a policy, one or more attributes associated with the connecting entity. The operations can also include partitioning the cloud environment, in accordance with the one or more attributes.

The operations can further include granting access to the cloud environment following the partitioning, and the partitioning can include provisioning one or more groups of resources for the connecting entity. The operations can further include maintaining a cloud security principal role identity for the connecting entity, and the operations can further include providing a specified set of attributes to the connecting entity upon establishing a connection to the cloud environment. The operations can further include assigning multiple sets of attributes to a cloud platform security principal, and the operations can further provision the connecting entity with only the resources needed for accessing the cloud environment based on the determined one or more attributes. The operations can further include granting access includes establishing a least privileged session for the connecting entity based on the determined one or more attributes, and the policy includes a permissions policy. The cloud environment may be a public cloud environment, and the connecting entity may be a computer system.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A method residing as instructions on a non-transitory computer-readable medium, the instructions being configured to cause a processor to perform operations comprising:
receiving information about a connecting entity, the connecting entity seeking to establish a connection to a cloud environment;
determining, based on a policy, one or more attributes associated with the connecting entity; and
partitioning the cloud environment, according to the one or more attributes.

2. The method of claim 1, wherein the operations further include granting access to the cloud environment following the partitioning.

3. The method of claim 1, wherein the partitioning includes provisioning one or more groups of resources for the connecting entity.

4. The method of claim 3, wherein the operations further include maintaining a cloud security principal role identity for the connecting entity.

5. The method of claim 1, wherein the operations further include providing a specified set of attributes to the connecting entity upon establishing a connection to the cloud environment.

6. The method of claim 1, further including assigning multiple sets of attributes to a cloud platform security principal.

7. The method of claim 1, further including provisioning the connecting entity with only the resources needed for accessing the cloud environment based on the determined one or more attributes.

8. The method of claim 2, wherein granting access includes establishing a least privileged session for the connecting entity based on the determined one or more attributes.

9. The method of claim 1, wherein the policy includes a permissions policy.

10. A system, comprising:
a processor;
a memory including instructions, which when executed, cause the processor to perform operations including:
receiving information about a connecting entity, the connecting entity seeking to establish a connection to a cloud environment;
determining, based on a policy, one or more attributes associated with the connecting entity; and
partitioning the cloud environment, according to the one or more attributes.

11. The system of claim 10, wherein the operations further include granting access to the cloud environment following the partitioning.

12. The system of claim 10, wherein the partitioning includes provisioning one or more groups of resources for the connecting entity.

13. The system of claim 12, wherein the operations further include maintaining a cloud security principal role identity for the connecting entity.

14. The system of claim 10, wherein the operations further include providing a specified set of attributes to the connecting entity upon establishing a connection to the cloud environment.

15. The system of claim 10, wherein the operations further include assigning multiple sets of attributes to a cloud platform security principal.

16. The system of claim 10, wherein the operations further include provisioning the connecting entity with only the resources needed for accessing the cloud environment based on the determined one or more attributes.

17. The system of claim 11, wherein granting access includes establishing a least privileged session for the connecting entity based on the determined one or more attributes.

18. The system of claim 10, wherein the policy includes a permissions policy.

19. The system of claim 10, wherein the cloud environment is a public cloud environment; and
wherein the connecting entity is a computer system.

20. A non-transitory computer-readable medium having instructions stored thereon on, the instructions, when executed, cause a processor to perform a method comprising:
receiving information about one or more users seeking to establish a connection to a cloud computing environment;
determining, based on a data structure, one or more attributes associated with the one or more users; and
partitioning the cloud computing environment responsive to the one or more attributes.
